(19) United States
(12) Patent Application Publication
(10) Pub. No.: US 2011/0235734 A1
(43) Pub. Date: Sep. 29, 2011

(54) ACTIVE ANTENNA ARRAY HAVING A SINGLE DPD LINEARISER AND A METHOD FOR PREDISTORTION OF RADIO SIGNALS

(76) Inventor: Peter Kenington, Chepstow (GB)

(21) Appl. No.: 12/732,631

(22) Filed: Mar. 26, 2010

(51) Int. Cl. H04B 7/02; H04L 25/03

(52) U.S. Cl. 375/267; 375/296

(57) ABSTRACT

An active antenna array comprises: a digital signal processor connected to a plurality of digital-to-analogue conversion blocks; a plurality of antenna elements; a plurality of transmission paths, whereby an individual one of the plurality of transmission paths is connected between an individual one of the digital-to-analogue conversion blocks and an individual one of the plurality of antenna elements, whereby an individual one of the plurality of transmission paths comprises a correction signal combiner and a feedback coupler; a plurality of paths connected between individual ones of the feedback couplers and a single feedback combiner; a single feedback path connected between the single feedback combiner and a correction signal calculation unit; and a single correction signal path connected between the correction signal calculation unit and at least two of the correction signal combiners.

A method for predistortion of radio signals in the active antenna array is also disclosed.

### CROSS-REFERENCE TO OTHER APPLICATIONS

This application is related to concurrently filed U.S. patent application Ser. No. ______ “Active Antenna Array having Analogue Transmitter Linearisation and a Method for Predistortion of Radio Signals” (Attorney Docket No. 4424-P05033US0) and U.S. patent application Ser. No. ______ “Active Antenna Array having Analogue Transmitter Linearisation and a Method for Predistortion of Radio Signals” (Attorney Docket No. 4424-P05035US0) as well as U.S. application Ser. No. 12/648,028 filed on 28 Dec. 2009.

The entire contents of the applications are incorporated herein by reference.

### FIELD OF THE INVENTION

The field of the invention relates to an active antenna array and a method for compensation of a plurality of transmit paths in the active antenna array.

### BACKGROUND OF THE INVENTION

The use of mobile communications networks has increased over the last decade. Operators of the mobile communications networks have increased the number of base stations in order to meet an increased demand for service by users of the mobile communications networks. The operators of the mobile communications network wish to reduce the running costs of the base station. One option to do this is to implement a radio system as an antenna-embedded radio forming an active antenna array. Many of the components of the antenna-embedded radio may be implemented on one or more chips.

Nowadays active antenna arrays are used in the field of mobile communications systems in order to reduce power transmitted to a handset of a customer and thereby increase the efficiency of the base station, i.e. the radio station. The radio station typically comprises a plurality of antenna elements, i.e. an antenna array adapted for transceiving a payload signal. Typically the radio station comprises a plurality of transmit paths and receive paths. Each of the transmit paths and receive paths are terminated by one of the antenna elements. The plurality of the antenna elements used in the radio station typically allows steering of a beam transmitted by the antenna array. The steering of the beam includes but is not limited to at least one of: detection of direction of arrival (DOA), beam forming, down tilting and beam diversity. These techniques of beam steering are well-known in the art.

The code sharing and time division strategies as well as the beam steering rely on the radio station and the antenna array to transmit and receive within well defined limits set by communication standards. The communications standards typically provide a plurality of channels or frequency bands useable for an uplink communication from the handset to the radio station as well as for a downlink communication from the radio station to the handset. In order to comply with the communication standards it is of interest to reduce so-called out of band emissions, i.e. transmission out of a communication frequency band or channel as defined by the communication standards.

For the transmission of the payload signal the base station comprises an amplifier within the transmit paths of the radio station. Typically, each individual one of the transmit paths comprises an individual one of the amplifiers. The amplifier typically introduces nonlinearities into the transmit paths. The nonlinearities introduced by the amplifier affect transfer characteristics of the transmit paths. The nonlinearities introduced by the amplifier distort the payload signal relayed by the radio station as a transmit signal along the transmit paths.

The transfer characteristics of the device describe how the input signal(s) generate the output signal. It is known in the art that the transfer characteristics of a nonlinear device, for example a diode or the amplifier, are generally nonlinear.

The concept of predistortion uses the output signal of the device, for example from the amplifier, for correcting the nonlinear transfer characteristics. The output signal is compared to the input signal by means of feedback and from this comparison correction coefficients are generated which are used to form or update an “inverse distortion” which is added and/or multiplied to the input signal in order to linearise the transfer characteristics of the device. The nonlinear transfer characteristics of the amplifier can be corrected by carefully adjusting the predistortion by means of the feedback.

To apply a correct amount of the predistortion to the amplifier it is of interest to know the distortions or nonlinearities introduced by the amplifier. This is commonly achieved by the feedback of the transmit signal to a predistorter. The predistorter is adapted to compare the transmitted signal with a signal prior to amplification in order to determine the distortions introduced by the amplifier. The signal prior to amplification is, for example, the payload signal.

The concept of predistortion has been explained in the above description in terms of correcting the transfer characteristics with respect to the amplitude of the transmit signal. It is understood that predistortion may alternatively and/or additionally correct for nonlinearities with respect to a phase of the input signal and the output signal.

The nonlinearities of the transfer characteristics of the complete transmit path from a digital signal processor to the antenna element are typically dominated by the nonlinearities in the transfer characteristics of the amplifier. It is therefore often sufficient to correct for the nonlinearities of the amplifier.

### SUMMARY OF THE INVENTION

This disclosure provides for an active antenna array comprising a digital signal processor connected to a plurality of digital-to-analogue conversion blocks and a plurality of antenna elements. A plurality of transmission paths is provided, whereby an individual one of the plurality of transmission paths is connected between an individual one of the digital-to-analogue conversion blocks and an individual one of the plurality of antenna elements. An individual one of the plurality of transmission paths comprises a correction signal combiner and a feedback coupler. The active antenna array comprises a plurality of paths connected between individual ones of the feedback couplers and a single feedback combiner, and a single feedback path connected between the single feedback combiner and a correction signal calculation unit. A single correction signal path is connected between the correction signal calculation unit and at least two of the correction signal combiners.

The use of single correction signal path enables the one or more of the plurality of transmission paths to be corrected.

In one aspect of the invention the single feedback combiner is one of a multi-way switch or an adder.

The digital to analogue conversion block may be one of a digital-to-analogue converter, a delta-sigma digital-to-analogue converter or a pair of digital-to-analogue converters supplying I & Q signals.

In another aspect of the invention, the active antenna array comprises a correction signal upconverter for upconverting the correction signal from a first frequency to a second frequency, thus generating an upconverted correction signal, and wherein the correction signal combiner is a correction signal summer adapted to operate at the second frequency and add the upconverted correction signal to a transmission signal.

In one aspect of the invention the correction signal combiner is adapted to multiply the single correction signal with a transmission signal. This allows the correction of the transmission signal on a transmission path.

The correction signal calculation unit may further comprise a predistorsion calculation unit and a correction signal generation unit.

The single correction signal path may comprise at least one of an amplitude controller and a phase controller.

The disclosure also teaches a method for predistortion of radio signals comprising correcting two or more of a plurality of analogue payload signals, thereby obtaining at least two corrected payload signals, amplifying the at least two corrected payload signals, extracting a portion of one or more of the at least two corrected payload signals as a single feedback signal, and adapting the correcting of the two or more of a plurality of analogue payload signals by combining the two or more of the more of the plurality of analogue payload signals with a correction signal generated by comparing the single feedback signal with at least one of the two or more of the plurality of analogue payload signals.

In one aspect of the disclosure, the method comprises switching between individual ones of the feedback signals; and using the switched one of the individual ones of the feedback signals for the generation of the correction signal of a corresponding one of the plurality of analogue payload signals.

In one aspect of the disclosure, the method comprises forming a composite feedback signal from a plurality of the at least one feedback signals; and using the composite feedback signal for the generation of the correction signal of a plurality of the analogue payload signals.

The disclosure also teaches a computer program product comprising a non-transitory computer-usable medium having control logic stored therein for causing a computer to manufacture an active antenna array for a mobile communications network, the active antenna array comprising: a digital signal processor connected to a plurality of digital-to-analogue conversion blocks; a plurality of antenna elements; a plurality of transmission paths, whereby an individual one of the plurality of transmission paths is connected between an individual one of the digital-to-analogue conversion blocks and an individual one of the plurality of antenna elements, whereby an individual one of the plurality of transmission paths comprises a correction signal combiner and a feedback coupler; a plurality of paths connected between individual ones of the feedback couplers and a single feedback combiner; a single feedback path connected between the single feedback combiner and a correction signal calculation unit; and a single correction signal path connected between the correction signal calculation unit and at least two of the correction signal combiners.

In a further aspect of the invention, a computer program product is disclosed which comprises a non-transitory computer-usable medium having control logic stored therein for causing an active antenna to execute a method for transmitting a plurality of individual radio signals comprising: first computer readable code means for correcting two or more of a plurality of analogue payload signals, thereby obtaining at least two corrected payload signals; second computer readable code means for amplifying the at least one corrected payload signal; third computer readable code means for extracting a portion of one or more of the at least one corrected payload signal as a single feedback signal; fourth computer readable control means for adapting the correcting of the two or more of a plurality of analogue payload signals by combining the two or more of the more of the plurality of analogue payload signals with a correction signal generated by comparing the single feedback signal with at least one of the two or more of the plurality of analogue payload signals

### DESCRIPTION OF THE FIGURES

FIG. 1 shows a first aspect of an active array antenna according to the present disclosure.

FIG. 2 shows a further aspect of the active array antenna according to the present disclosure.

FIG. 3 shows a further aspect of the active array antenna according to the present disclosure.

FIG. 4 shows a further aspect of the active array antenna according to the present disclosure.

FIG. 5 shows a further aspect of the active array antenna according to the present disclosure

FIG. 6. shows a method for linearising a payload signal according to the present disclosure.

FIG. 7. shows an overview of the method according to one aspect of this disclosure

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature or features of a different aspect or aspects and/or embodiments of the invention.

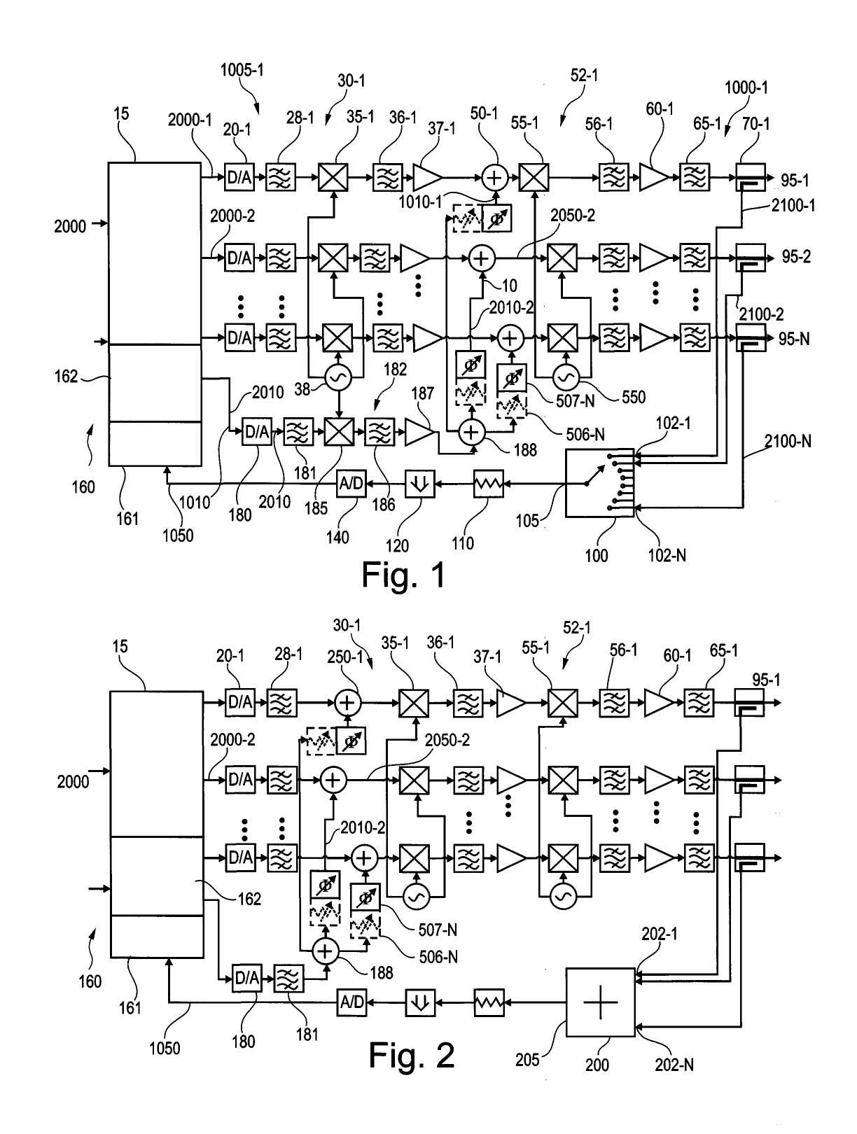

FIG. 1 shows a first aspect of an active antenna array 1 according to the present disclosure. A digital signal processor (DSP) 15 receives and processes a payload signal 2000.

The payload signal 2000 typically comprises an in phase portion (I) and an out of phase portion, i.e. a quadrature portion (Q). The digital formats for the payload signal 2000 in an (I, Q) format are known in the art and will not be explained any further.

The active antenna array 1 as shown in FIG. 1 comprises at least one transmit path 1000-1, 1000-2, . . . , 1000-N. There are three different transmit paths 1000-1, 1000-2, . . . , 1000-N displayed within FIG. 1. It will however be appreciated by the person skilled in the art that the number of transmit paths 1000-1, 1000-2, . . . , 1000-N can be changed. In a typical implementation there will be eight or sixteen transmit paths, but this is not limiting of the invention. Each one of the transmit paths 1000-1, 1000-2, . . . , 1000-N is terminated by an antenna element 95-1, 95-2, . . . , 95-N.

In a transmit path 1000-1, 1000-2, . . . , 1000-N the payload signal 2000 is processed by the digital signal processor 15, for example undergoing filtering, upconversion, crest factor reduction and beamforming processing, prior to being forwarded to a digital-to-analogue conversion block 20-1, 20-2, . . . , 20-N adapted to convert the payload signal 2000 into an analogue payload signal 2000-1, 2000-2, . . . , 2000-N as a transmit signal. The analogue payload signal 2000-1, 2000-2, . . . , 2000-N is provided as pairs of amplitude and phase values (A, P) or I & Q components. It will be noted that the payload signal 2000 is not changed by the selected form of the payload signal 20001.e. I and Q components or pairs of phase and amplitude (A, P).

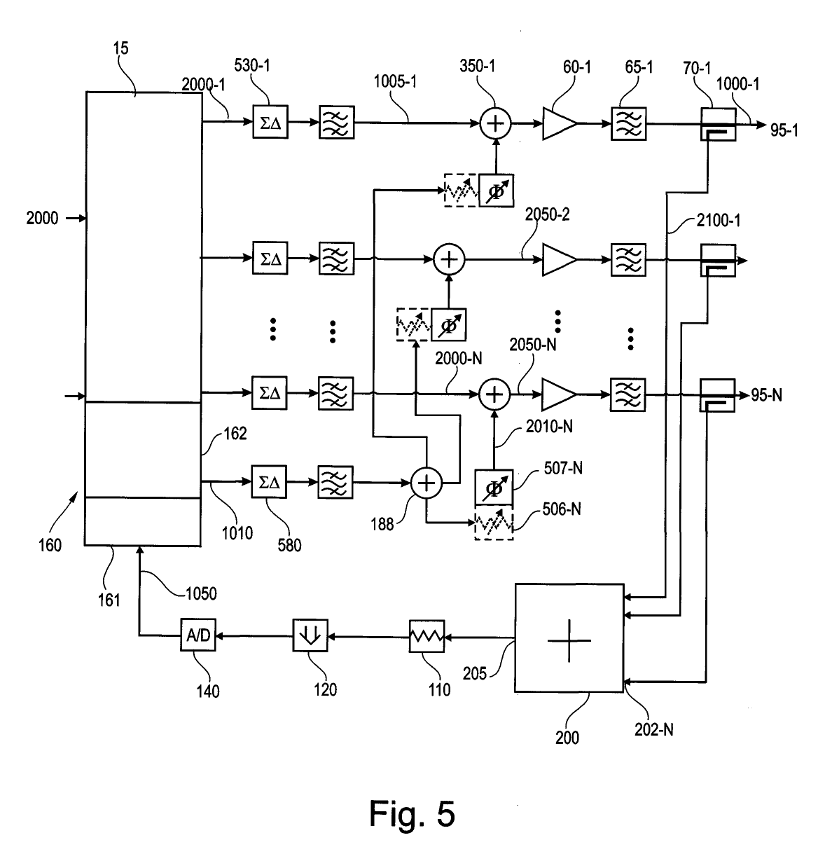

The digital-to-analogue conversion block 20-1, 20-2, . . . , 20-N may comprise conventional digital-to-analogue converters 20-1, 20-2, . . . , 20-N. Alternately, the digital-to-analogue conversion block 20-1, 20-2, . . . , 20-N may be in the form of delta-sigma digital-to-analogue converters (as will be shown in FIG. 5).

The analogue payload signal 2000-1, 2000-2, . . . , 2000-N is passed to a transmission path 1005-1, 1005-2, . . . , 1005-N. Each one of the transmission paths 1005-1, 1005-2, . . . , 1005-N is connected between a digital-to-analogue conversion block 20-1, 20-2, . . . , 20-N and an antenna element 95-1, 95-2, . . . , 95-N.

The transmission paths 1005-1, 1005-2, . . . , 1005-N comprise a first filter 28-1, 28-2, . . . , 28-N. The first filter 28-1, 28-2, . . . , 28-N may be any filter adapted to appropriately filter the analogue payload signal 2000-1, 2000-2, . . . , 2000-N leaving the digital-to-analogue conversion block 20-1, 20-2, . . . , 20-N after conversion of the payload signal 2000 into an analogue form. Typically, the first filter 28-1, 28-2, . . . , 28-N comprises a band pass filter. The first filter 28-1, 28-2, . . . , 28-N allows the analogue payload signal 2000-1, 2000-2, . . . , 2000-N to pass the first filter 28-1, 28-2, . . . , 28-N in a group of frequency bands or channels as defined by the communication standard. The purpose of the first filter 28-1, 28-2, . . . , 28-N is to remove unwanted products from the digital to analogue conversion process, such as noise or spurious signals.

The output of the first filter 28-1, 28-2, . . . , 28-N is passed to an up-conversion block 30-1, 30-2, . . . , 30-N. The up-conversion block 30-1, 30-2, . . . , 30-N is adapted for up-converting the frequency of the analogue payload signal 2000-1, 2000-2, . . . , 2000-N. The up-conversion block 30-1, 30-2, . . . , 30-N comprises an up-mixer 35-1, 35-2, . . . , 35-N along with a second filter 36-1, 36-2, . . . , 36-N. The up-mixers 35-1, 35-2, . . . , 35-N are known in the art and will not be discussed further within this disclosure. The up-conversion block 30-1, 30-2, . . . , 30-N comprises a local oscillator input port and this receives a local oscillator signal from the local oscillator 38. Three signal up-conversion blocks 30-1, 30-2, . . . , 30-N are shown in FIG. 1, all of which are connected to a first local oscillator 38. Having the single first local oscillator 38 ensures that the analogue payload signals 2000-1, . . . , 2000-N on each one of the transmission paths 1005-1, 1005-2, . . . , 1005-N are up-converted coherently.

The output of the up-conversion block 30-1, 30-2, . . . , 30-N, is amplified in a first amplifier 37-1, 37-2, . . . , 37-N and passed to an analogue correction signal combiner 50-1, 50-2, . . . , 50-N. The analogue correction signal combiner 50-1, 50-2, . . . , 50-N is adapted to combine a correction signal 1010-1, 1010-2, 1010-N with the analogue payload signal 2000-1, 2000-2, . . . , 2000-N thus forming a corrected payload signal 2050-1, 2050-2, . . . , 2050-N. There are three analogue correction signal combiners 50-1, 50-2, . . . , 50-N and three corrected payload signals 2050-1, 2050-2, . . . , 2050-N shown in FIG. 1. Any other number of the predistortions and/or corrected payload signals is conceivable. The corrected payload signals are relayed along the transmission paths 1005-1, 1005-2, . . . , 1005-N as transmit signals.

In the aspect of the invention shown in FIG. 1, the up-conversion block 30-1, 30-2, . . . , 30-N is adapted to convert the analogue payload signal 2000-1, 2000-2, . . . , 2000-N into an intermediate frequency payload signal and the analogue correction signal combiner 50-1, 50-2, . . . , 50-N is adapted to work in the intermediate frequency range.

One of the analogue correction signal combiners 50-1, 50-2, . . . , 50-N is provided for each one the transmission paths 1005-1, 1005-2, . . . , 1005-N. The analogue correction signal combiners 50-1, 50-2, . . . , 50-N enable the combining of the analogue payload signal 2000-1, 2000-2, . . . , 2000-N with the correction signal 2010-1, 2010-2, . . . , 2010-N, for individual linearization of each one of the transmission paths 1005-1, 1005-2, . . . , 1005-N.

In FIG. 1, the output of the analogue correction signal combiner 50-1, 50-2, . . . , 50-N is passed into a second up-conversion block 52-1, 52-2, . . . , 52-N. The second up-conversion block 52-1, 52-2, . . . , 52-N is adapted to convert the corrected payload signal 2050 from the intermediate frequency range to a RF frequency range. Each one of the up-conversion blocks 52-1, 52-2, . . . , 52-N comprises a second up-mixer 55-1, 55-2, . . . , 55-N along with a third filter 56-1, 56-2, . . . , 56-N. The second up-mixers 55-1, 55-2, . . . , 55-N are known in the art and will not be discussed further within this disclosure. The second up-conversion block 52-1, 52-2, . . . , 52-N receives a local oscillator signal from a second local oscillator 550. Three signal up-conversion blocks 52-1, 52-2, . . . , 52-N are shown in FIG. 1, all of which are connected to the single second local oscillator 550. Having the single second local oscillator 550 ensures that the up-converted payload signal on each one of the transmission paths 1005-1, 1005-2, . . . , 1005-N is up-converted coherently.

FIG. 1 shows an active array antenna with a transmission path 1005-1, 1005-2, . . . , 1005-N comprising two up-conversion blocks 30-1, 30-2, . . . , 30-N and 52-1, 52-2, . . . , 52-N. However, it will be appreciated that the present invention should not be limited to a given number of up-conversion blocks. There may be transmission paths 1005-1, 1005-2, . . . , 1005-N with no up-conversion blocks. Alternately, there may be transmission paths 1005-1, 1005-2, . . . , 1005-N with one or more up-conversion blocks 30-1, 30-2, . . . , 30-N and 52-1, 52-2, . . . , 52-N, depending on the active antenna array requirements.

The transmission path 1005-1, 1005-2, . . . , 1005-N further comprises a second amplifier 60-1, 60-2, . . . , 60-N as well as a fourth filter 65-1, 65-2 . . . , 65-N and a coupler 70-1, 70-2, . . . , 70-N. The transfer characteristics of the second amplifiers 60-1, 60-2, . . . , 60-N are typically designed to be as identical as possible for each one of the transmission paths 1005-1, 1005-2, . . . , 1005-N. Typically a group of the second amplifiers 60-1, . . . , 60-N is fabricated in a single batch. The use of the second amplifiers 60-1, . . . , 60-N belonging to the single batch increases the likelihood of the second amplifiers 60-1, . . . , 60-N having substantially identical characteristics. This is most notably the case if the second amplifiers are fabricated using monolithic semiconductor, hybrid or integrated circuit techniques.

The fourth filter 65-1, . . . , 65-N may be any filter adapted to appropriately filter the up-converted transmit signal leaving the fourth amplifier 60-1, . . . , 60-N after an amplification of the corrected payload signal. Typically, the fourth filter 65-1, . . . , 65-N comprises a band pass filter to remove out of band signals and it may form part of a duplexer arrangement, with the receive filtering aspects not shown in FIG. 1. The fourth filter 65-1, . . . , 65-N allows the up-converted transmit signal to pass the filter 65-1, . . . , 65-N in a group of frequency bands or channels.

The coupler 70-1, . . . , 70-N is adapted to extract a portion of the up-converted transmit signal as a feedback signal 2100-1, 2100-2, . . . , 2100-N out of the transmission path 1005-1, 1005-2, . . . , 1005-N. The coupler 70-1, . . . , 70-N is known in the art and may, for example, comprise a circulator or a directional coupler. Obviously any other form of coupler 70-1, . . . , 70-N is appropriate for use with the present disclosure, provided the coupler 70-1, . . . , 70-N allows the extraction of a feedback signal 2100-1, 2100-2, . . . , 2100-N out of the up-converted transmit signal. The feedback signal 2100-1, 2100-2, . . . , 2100-N is passed to a combiner 100.

In the first aspect of the disclosure shown on FIG. 1, the combiner is a switch 100. The switch 100 comprises a plurality of switch inputs 102-1, 102-2, . . . , 102-N and one switch output 105. The switch 100 is adapted to forward a selected one of a plurality of input signals (i.e. the feedback signal 2100-1, 2100-2, . . . , 2100-N) from the switch inputs 102-1, . . . , 102-N to the switch output 105. In FIG. 1 the selected one of the feedback signals 2100-1, 2100-2, . . . , 2100-N at the switch inputs 102-1, . . . , 102-N is forwarded to the switch output 105.

The switch 100 may be switched from one of the switch inputs 102-1, . . . , 102-N to the next one of the switch inputs 102-1, . . . , 102-N in a sequential switching manner. If the highest switch input 102-N is reached the switch returns to the first switch input 102-1 and vice versa. It is also possible to operate the switch in a non-sequential manner and this may be advantageous where there is merit in concentrating linearization upon a particular transmit path or paths, for example by visiting certain switch settings more frequently than others. This could occur, for example, where one or more of the transmission paths 1005-1, 1005-2, . . . , 1005-N has a greater impact upon the overall spectral output of the antenna array due to, for example, the use of a higher power amplifier in that one or more of the transmission paths 1005-1, 1005-2, . . . , 1005-N.

The selected one of the feedback signals 2100-1, 2100-2, . . . , 2100-N is fed into a common feedback path 1050 leading from the switch output 105 to a correction signal calculation unit 160.

The common feedback path 1050 comprises an attenuator 110. The attenuator 110 serves to reduce a power level of the selected one of the feedback signals 2100-1, 2100-2, . . . , 2100-N. The attenuator 110 may be useful to ensure that the selected one of the feedback signals 2100-1, 2100-2, . . . , 2100-N does not exceed a power rating of the downconverting and filtering unit 120. It should be noted that the attenuator 110 should be of a substantially linear transfer characteristic over the frequency and power range of transmission of the active antenna array 1. The linear transfer characteristics of the attenuator 110 prevents further nonlinearities being introduced to the selected one of the feedback signals 2100-1, 2100-2, . . . , 2100-N stemming from the attenuator 110.

The common feedback path 1050 comprises a down-converting and filtering unit 120 adapted to convert the selected one of the feedback signals 2100-1, 2100-2, . . . , 2100-N back to lower frequencies and to filter the out of band signals. This unit will typically comprise a single down mixer, filter and local oscillator, but may contain two or more downconversion stages, each comprising a down mixer, filter and local oscillator. Additional low-power amplification stages may also be included, as needed. The common feedback path 1050 further comprises an analogue-to-digital converter 140. Any analogue-to-digital converter 140 may be used, either conventional or in the form of a delta-sigma analogue-to-digital converter. It is convenient to place the analogue-to-digital converter 140 downstream of the attenuator 110. It would also be possible to place the analogue-to-digital converter 140 upstream from the attenuator 110, in which case the attenuator would be a digital attenuator. Placing the analogue-to-digital converter 140 downstream of the attenuator 110 allows provision of a defined power level of the selected one of the feedback signals 2100-1, 2100-2, . . . , 2100-N for all of the transmission paths 1005-1, 1005-2, . . . , 1005-N. The defined power level of the selected one of the feedback signals 2100-1, 2100-2, . . . , 2100-N may be of interest in order to use a full dynamic range of the analogue-to-digital converter 140, as is known in the art.

The output of the analogue-to-digital converter 140 is passed to the correction signal calculation unit 160 for processing. The correction signal calculation unit 160 is adapted to derive the predistortion coefficients or look-up table values and generate therefrom the correction signal 2010 to be combined with the payload signal 2000 for forming the corrected payload signal 2050. The correction signal calculation unit 160 may be implemented using the DSP 15.

The use of the common feedback path 1050 reduces the complexity of the radio station 1. Individual feedback paths are no longer needed for each individual one of the transmission paths 1005-1, 1005-2, . . . , 1005-N, i.e. for each individual one of the feedback signals 2100-1, 2100-2, . . . , 2100-N. Each one of the feedback signals 2100-1, 2100-2, . . . , 2100-N is a representation of the nonlinearities accumulated along an individual one of the transmission paths 1005-1, 1005-2, . . . , 1005-N. The selected one of the feedback signals 2100-1, 2100-2, . . . , 2100-N represents one of the transmission paths 1005-1, 1005-2, . . . , 1005-N.

With the active antenna array 1 of FIG. 1, only one correction signal calculation unit 160 is needed with the common feedback path 1050, which reduces complexity and hardware cost of the active antenna array 1 as well as saving real estate on the chip.

There may be one or more DSPs 15 used in forming the correction signal calculation unit 160 and the beamforming and digital up-conversion of the input signal. The correction signal calculation unit 160 comprises a predistortion calculation unit 161 and a correction signal generation unit 162. The predistortion calculation unit 161 is adapted for deriving the predistortion coefficients or look-up table values to be imposed on the payload signal. The correction signal generation unit 162 is adapted for generating the correction signal 2010-1, 2010-2, . . . , 2010-N using the predistortion coefficients or look-up table values derived from the predistortion calculation unit 162.

The predistortion coefficients or look-up table values may be stored as a number in a lookup table or as a table of polynomial coefficients describing the nonlinearities of the predistortion characteristic. The predistortion calculation unit 161 is adapted to compare the selected one of the feedback signals 2100-1, 2100-2, . . . , 2100-N with the payload signal 2000. Subsequently, the predistortion calculation unit 161 is adapted to extract the nonlinearities between a selected one of the feedback signals 2100-1, 2100-2, . . . , 2100-N and the payload signal 2000 and to adjust the predistortion coefficients or look-up table values, if necessary. Alternatively, the predistortion calculation unit 161 may be adapted to extract the nonlinearities between a combination of the feedback signals 2100-1, 2100-2, . . . , 2100-N and the payload signal 2000. In this case an average or weighted average of the predistortion coefficients or look-up table values will result.

The output of the predistortion calculation unit 161 is passed to the correction signal generation unit 162 for the generation of the single correction signal 2010. The correction signal 2010 is forwarded on a single correction signal path 1010. The single correction signal path 1010 comprises a second digital-to-analogue conversion block 180 for converting the single correction signal 2010 into an analogue single correction signal 2010. The second digital-to-analogue conversion block 180 may comprise a conventional digital-to-analogue converter 180. Alternately, the second digital-to-analogue conversion block 180 may be in the form of delta-sigma digital-to-analogue converter.

The single correction signal 2010 is passed to a fifth filter 181. The fifth filter 181 may be any filter adapted to appropriately filter the single correction signal 2010 leaving the second digital-to-analogue conversion block 180 after conversion of the single correction signal 2010 into an analogue form. The purpose of the fifth filter 181 is to remove unwanted products from the digital to analogue conversion process, such as noise or spurious signals.

The output of the fifth filter 181 is passed to a third up-conversion block 182. The third up-conversion block 182 is adapted for up-converting the single correction signal 2010. The third up-conversion block 182 comprises a third up-mixer 185 along with a sixth filter 186. The third up mixer 185 is known in the art and will not be discussed further within this disclosure. The third up-conversion block 182 comprises a local oscillator input port and this receives the first local oscillator signal from the first local oscillator 38. Having the single first local oscillator 38 ensures that the single correction signal 2010 is up-converted coherently with the analogue payload signals 2000-1, . . . , 200-N on each one of the transmission paths 1005-1, 1005-2, . . . , 1005-N.

The output of the third up-conversion block 182 is amplified in a third amplifier 187 and passed to a splitter 188. The splitter 188 is adapted to split the single correction signal 2010 into a plurality of identical correction signals 2010-1, 2010-2, . . . , 2010-N to be passed onto a plurality of correction signal paths 1010-1, . . . , 1010-N to the correction signal combiners 50-1, . . . , 50-N. There are as many correction signal paths 1010-1, . . . , 1010-N as correction signal combiners 50-1, . . . , 50-N (three are shown on FIG. 1).

The correction signal paths 1010-1, . . . , 1010-N comprise an amplitude controller 506-1, 506-2, . . . , 506-N and phase controller 507-1, 507-2, . . . , 507-N. The function of the amplitude controller 506-1, 506-2, . . . , 506-N and the phase controller 507-1, 507-2, . . . , 507-N is to alter the gain and phase of the correction signals 2010-1, 2010-2, . . . , 2010-N, in order to adapt the characteristics of the correction signals 2010-1, 2010-2, . . . , 2010-N to the respective analogue payload signal 2000-1, 2000-2, . . . , 2000-N. This may be necessary as the phase of the analogue payload signal 2000-1, 200-2, . . . , 2000-N on each one of the transmission paths 1005-1, 1005-2, . . . , 1005-N may vary depending on the characteristics of the signal to be outputted from the active antenna array 1, for example due to beamforming processing having taken place on the signal.

The correction signal 2010-1, 2010-2, . . . , 2010-N is passed to the correction signal combiner 50-1, 50-2, . . . , 50-N. The correction signal 2010-1, 2010-2, . . . , 2010-N is combined with the analogue payload signal 2000-1, 2000-2, . . . , 2000-N to form the corrected payload signal 2050-1, 2050-2, . . . , 2050-N.

It will be understood that each of the plurality of correction signal combiners 50-1, 50-2, . . . , 50-N receives the correction signal 2010-1, 2010-2, . . . , 2010-N based on a single correction signal 2010, wherein the phase and amplitude of the correction signals 2010-1, 2010-2, . . . , 2010-N have been adapted as described above. The simultaneous (or quasi simultaneous) correction of the analogue payload signal 2000-1, 2000-2, . . . , 2000-N with the same correction signal 2010 for each of the correction signal combiners 50-1, 50-2, . . . , 50-N can be contemplated because in radio transmission, it is not necessary for each one of the antenna elements to meet the standard requirements of the radio transmission but for the output signal to be a composite of each individual signal from the plurality of antenna elements forming the active antenna array 1. All of the DSP processing effort devoted to the correction signal calculation unit 160 can be concentrated on a single feedback signal, thereby improving the accuracy of the predistortion updating process.

The switch 100 is switched from one of the switch inputs 102-1, . . . , 102-N to the next in a sequential switching (or otherwise, as described above). An iterative process can be implemented, with a single correction signal 2010 being generated with the correction signal calculation unit 160. The single correction signal 2010 may be generated based upon the switched one of the feedback signals 2100-1, 2100-2, . . . , 2100-N. Alternately, a memory may be provided to store the switched one of the feedback signal 2100-1, 2100-2, . . . , 2100-N. An average or a composite feedback signal 2100 may be generated for evaluating the predistortions in the predistortion calculation unit 161. The feedback process may also be adapted to control the amplitude controllers 506-1, 506-2, . . . , 506-N and phase controllers 507-1, 507-2, . . . , 507-N. For example, when the switch 100 selects switch input 102-1, an upper set of amplitude and phase controllers 506-1, 506-2, . . . , 506-N, 507-1, 507-2, . . . , 507-N can be adjusted to minimise the distortion present in the output spectrum, as seen at the corresponding antenna output 95-1. Alternatively, these amplitude and phase controllers 506-1, 506-2, . . . , 506-N, 507-1, 507-2, . . . , 507-N can be set directly by the DSP 15 based upon the amplitude and phase weighting imposed upon the corresponding payload signal 2000-1 by the beamforming processing for the selected transmission path 1005-1.

With the active antenna 1 of FIG. 1, the predistortion process is a broadband predistortion addition process covering the entire wanted spectrum. This process is referred to as a “digital IF predistortion” or “digital baseband predistortion”.

FIG. 2 shows an alternative aspect of the active antenna array 1. The alternative aspect of the active antenna array 1 of FIG. 2 differs from FIG. 1 in that the signal combiner contained in the feedback path is implemented as an RF adder 200 instead of the switch 100 of FIG. 1. Those elements of FIG. 2 which are identical to the elements of FIG. 1 have identical reference numerals.

The adder 200 comprises a plurality of adder inputs 202-1, 202-2, . . . , 202-N and one adder output 205. In this aspect of the disclosure, the adder 200 performs a summation of all of the feedback signals 2100-1, 2100-2, . . . , 2100-N at the plurality of adder inputs 202-1, 202-2, . . . , 202-N. In other words, a parallel averaging over the plurality of the feedback signals 2100-1, 2100-2, . . . , 2100-N is performed. The output 205 of the adder 200 is a single composite feedback signal 2150 as a composite of the nonlinearities over the plurality of the transmission paths 1005-1, 1005-2, . . . , 1005-N. It is possible for the summation process to be ‘weighted’, i.e. for some inputs to the adder 200 to have a greater representation in the adder output signal 205 than other inputs. This may be desirable in cases where the amplifier power levels from the RF power amplifiers, 60-1, 60-2, . . . , 60-N differ from one another, leading to some of the RF power amplifiers, 60-1, 60-2, . . . , 60-N having a greater contribution than others to the unwanted out-of-band emissions from the active antenna system.

The adder output 205 is fed on the feedback path 1050 to the correction signal calculation unit160. The correction signal calculation unit 160 is adapted to update the predistortion coefficients or look-up table values and to generate the correction signal 1010. The correction signal calculation unit 160 may be implemented using the DSP 15.

In the aspect of FIG. 2, the correction signal 2010 is generated based upon the averaging of the feedback signal 2100s. The adder 200 is a simple component which is easily fabricated and which does not require any form of control compared to the switch 100 of FIG. 1.

The alternative aspect of the active antenna array 1 of FIG. 2 further differs from FIG. 1 in that the correction signal combiner 250-1, 250-2, . . . , 250-N is positioned after the first filter 28-1, 28-2, . . . , 28-N and before the first up-conversion block 30-1, 30-2, . . . , 30-N. Accordingly the correction signal path 1010 has been modified to omit the third up-conversion block 182.

The single correction signal path 1010 of FIG. 2 comprises the second digital-to-analogue conversion block 180 for converting the single correction signal 2010 into an analogue single correction signal 2010. The second digital-to-analogue conversion block 180 may comprise a conventional digital-to-analogue converter 180. Alternately, the digital-to-analogue conversion block may be in the form of delta-sigma digital-to-analogue converter 180.

The single correction signal 2010 is passed to the fifth filter 181. The fifth filter 181 may be any filter adapted to appropriately filter the analogue single correction signal 2010 leaving the second digital-to-analogue conversion block 180 after conversion of the payload signal 2000 into analogue form. The purpose of the fifth filter 181 is to remove unwanted products from the digital to analogue conversion process, such as noise or spurious signals.

The output of the fifth filter 181 is passed to a splitter 188. The splitter 188 is adapted to split the single analogue single correction signal 2010 into a plurality of identical correction signals 2010-1, 2010-2, . . . , 2010-N to be passed onto a plurality of correction signal paths 1010-1′, 1010-2′, . . . , 1010-N′ to the correction signal combiners 250-1, 250-2, . . . , 250-N.

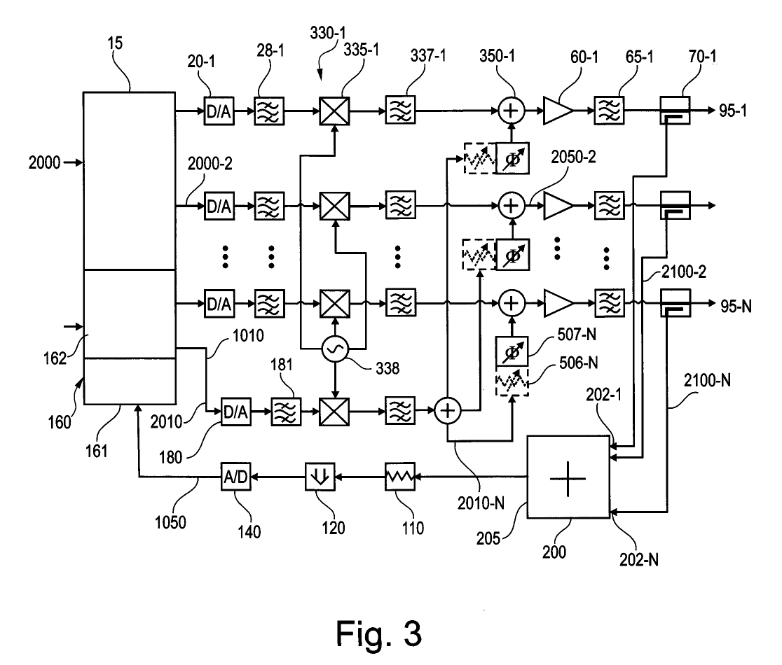

FIG. 3 shows an alternative aspect of the active antenna array 1. The alternative aspect of the active antenna array 1 of FIG. 3 differs from FIGS. 1 and 2 in that there is only one stage of analogue up-conversion instead of two stages of analogue up-conversion as shown in FIGS. 1 and 2. Accordingly, the transmission path 1005-1, 1005-2, . . . , 1005-N of the active antenna array 1 of FIG. 3 comprises a single up-conversion block 330-1, 330-2, . . . , 330-N, upstream of the correction signal combiner 350-1, 350-2, . . . , 350-N. Each one of the up-conversion blocks 330-1, 330-2, . . . , 330-N comprises a single up-mixer 335-1, 335-2, . . . , 335-N along with a single filter 336-1, 336-2, . . . , 336-N. The single up mixers 335-1, 335-2, . . . , 335-N are known in the art and will not be discussed further within this disclosure. The single up-conversion block 330-1, 330-2, . . . , 330-Ns comprises a local oscillator input and receives the local oscillator signal from the single local oscillator 338. Three signal up-conversion blocks 330-1, 330-2, . . . , 330-N are shown, all connected to the single local oscillator 338.

The single up-conversion block 330-1, 330-2, . . . , 330-N is adapted to convert the payload signal to a radio frequency band.

A further difference of the active array antenna 1 of FIG. 3 from that of FIG. 2 is that the correction signal combiner 350-1, 350-2, . . . , 350-N is adapted to work in the radio frequency range.

The output of the correction signal combiner 350-1, 350-2, . . . , 350-N is passed to the RF amplifier 60-1, 60-2, . . . , 60-N, filtered through filter 65-1, 65-2, . . . , 65-N, and passed to the coupler 70-1, 70-2, . . . , 70-N. The coupler 70-1, . . . , 70-N is adapted to extract a portion of the upconverted transmit signal as the feedback signal 2100-1, 2100-2, . . . , 2100-N out of the transmission path 1005-1, 1005-2, . . . , 1005-N. The feedback signal 2100-1, 2100-2, . . . , 2100-N is passed to the adder 200 for further processing, similar to that described above with reference to FIG. 2. It will, of course, be appreciated that the adder 200 could be replaced by the switch 100 as known from the aspect of the invention described in FIG. 1.

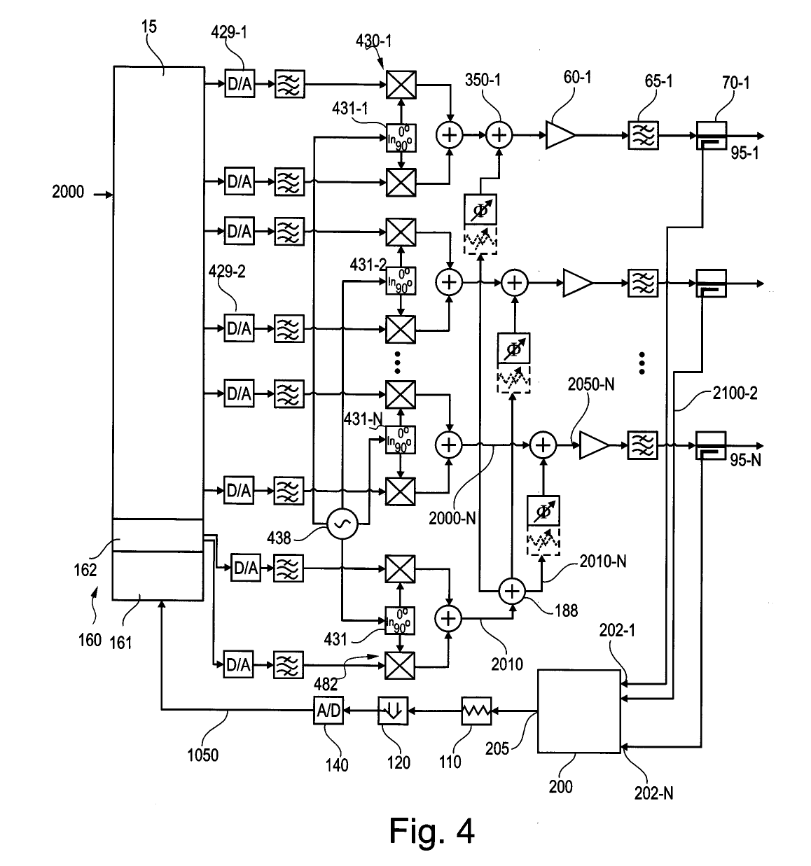

FIG. 4 shows an alternative aspect of the active antenna array 1. The alternative aspect of the active antenna array 1 of FIG. 4 differs from FIG. 3 in that the first digital-to-analogue converters 20-1, 20-2, . . . , 20-N and the single up-conversion block 330-1, 330-2, . . . , 330-N are replaced by a pair of digital-to-analogue converters 429-1, 429-2, . . . , 429-N and quadrature up-converters 430-1, 430-2, . . . , 430-N supplying RF signals. A local oscillator 438 supplies an oscillator signal to the pair of up-converter mixers 430-1, 430-2, . . . , 430-N via the quadrature splitter 431-1, 431-2, . . . , 431-N. The digital-to-analogue converters 429-1, 429-2, . . . , 429-N and quadrature splitters 431-1, 431-2, . . . , 431-N can take a number of forms; these are known in the art and will not be explained any further.

Similarly the digital-to-analogue converter 180 and the up-conversion block 182 in the correction signal path 1010 are replaced by a pair of digital-to-analogue converters and quadrature up-converters 482 supplying RF signals. The second local oscillator 438 supplies an oscillator signal to the pair of up-converter mixers 482 via the quadrature splitter 431.

FIG. 5 shows an alternative aspect of the active antenna array 1. The alternative aspect of the active antenna array 1 of FIG. 5 differs from the active antenna arrays 1 of FIGS. 1-3 in that the digital-to-analogue converters 20-1, 20-2, . . . , 20-N are replaced by the delta-sigma digital-to-analogue converters 530-1, 530-2, . . . , 530-N. The delta-sigma digital-to-analogue converters 530-1, 530-2, . . . , 530-N remove the need for the up mixers 35-1, 35-2, . . . , 35-N in the transmission paths 1005-1, 1005-2, . . . , 1005-N, as is needed with the digital-to-analogue converters 20-1, 20-2, . . . , 20-N of FIGS. 1-3. It will be apparent that the use of the delta-sigma digital-to-analogue converters 530-1, . . . , 530-N is of interest in order to reduce the system complexity of the antenna array 1, as the up mixers 35-1, 35-2, . . . , 35-N are no longer needed. Similarly the digital-to-analogue converter 180 in the correction signal path 1010 is replaced by the delta-sigma digital-to-analogue converters 580 supplying RF signals

It will be appreciated that the delta-sigma digital-to-analogue converters 530-1, . . . , 530-N, 580, and the digital-to-analogue converters 30-1, . . . , 30-N, 180 in combination with the up converters 35-1, . . . , 35-N, 185, can be interchanged or used in combination. It will also be appreciated that the downconverter 120 and the analogue-to-digital converter 140 in the feedback path in any of FIGS. 1-5 can be replaced by a delta-sigma ADC and associated filter, with a similar reduction in complexity to that mentioned above with respect to the use of delta-sigma digital to analogue conversion.

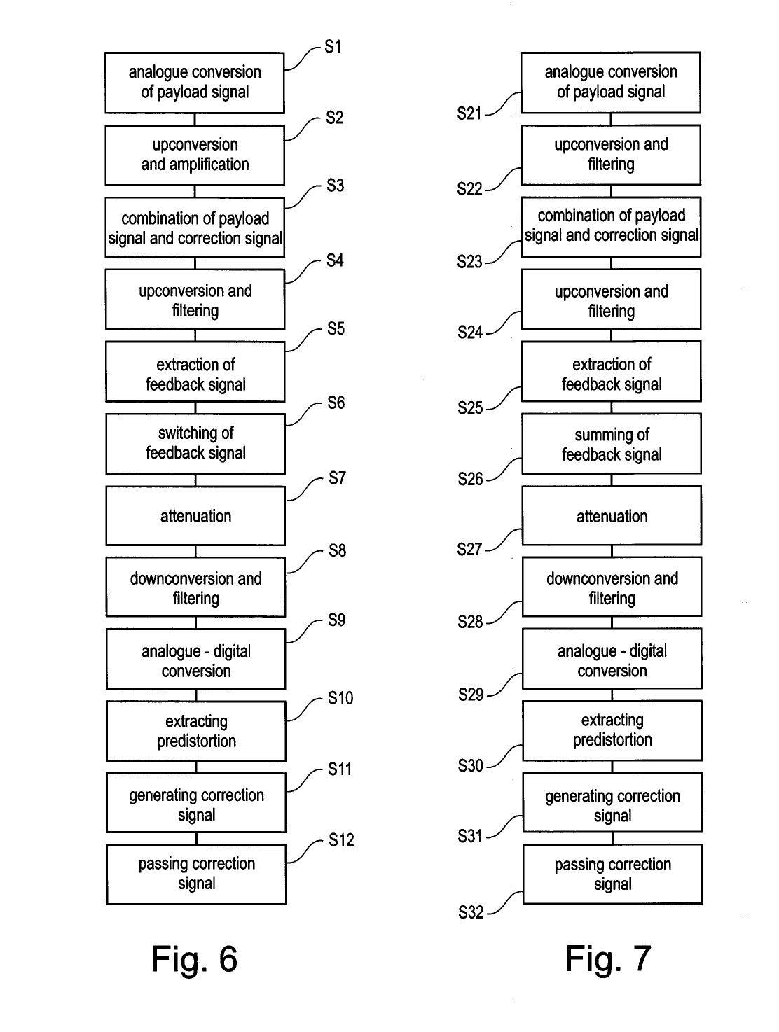

FIG. 6 shows an overview of the method according to one aspect of this disclosure, and is described in conjunction with the active antenna array of FIG. 1.

In step S1, the payload signal 2000 is converted to the analogue payload signal 2000-1, 2000-2, . . . , 2000-N. The analogue payload signal 2000-1, 2000-2, . . . , 2000-N is forwarded along the transmission path 1005-1, 1005-2, . . . , 1005-N. The analogue payload signal 2000-1, 2000-2, . . . , 2000-N is upconverted into intermediate frequencies and amplified by IF amplifier 37-1, 37-2, . . . , 37-N (step S2)

In step S3, the analogue payload signal 2000-1, 2000-2, . . . , 2000-N is passed to the analogue IF correction signal combiner 50-1, 50-2, . . . , 50-N, wherein a correction signal 2010-1, 2010-2, . . . , 2010-N is combined with the analogue payload signal 2000-1, 2000-2, . . . , 2000-N thereby forming the corrected payload signal 2050-1, . . . , 2050-N. The analogue payload signal 2000-1, 2000-2, . . . , 2000-N is the intended signal to be relayed along the transmission paths 1005-1, 1005-2, . . . , 1005-N. The corrected payload signal 2050-1, . . . , 2050-N is forwarded along the transmission paths 1005-1, 1005-2, . . . , 1005-N. The combining of the correction signal 2010-1, 2010-2, . . . , 2010-N with the analogue payload signal 2000-1, 200-2, . . . , 2000-N comprises adding and/or multiplying correction signal 2010-1, 2010-2, . . . , 2010-N to the analogue payload signal 2000-1, 2000-2, . . . , 2000-N.

An up-conversion and filtering of the corrected payload signal 2050-1, 2050-2, . . . , 2050-N (step S4) follows the step S3 of imposing the predistortions onto the selected one of the analogue payload signals 2000-1, 2000-2, . . . , 2000-N. The corrected payload signal 2050-1, 2050-2, . . . , 2050-N is up converted to RF frequencies in the second up-conversion block 52-1, 52-2, . . . , 52-N. The step S4 of filtering may comprise the use of the band pass filter 56-1, 56-2, . . . , 56-N. The band pass filter 56-1, 56-2, . . . , 56-N may comprise a filtering characteristic as defined by the communication protocol.

The method outlined in FIG. 8 is described with two up-conversion stages as shown in FIG. 1. It will be appreciated that this is not limiting and that the method could comprise a single up-conversion stages as required (as known from FIGS. 3-5). It should be further noted that the method is described with a correction signal combiner 50-1, 50-2, . . . , 50-N working at IF frequencies. It will be appreciated that the correction signal combiner could be working in RF frequencies (as known from FIGS. 3-5). Any combination of up-conversion blocks and correction signal combiner can be contemplated.

An extraction step S5 comprises the extraction of a feedback signal 2100-1, 2100-2, . . . , 2100-N out of one or more of the transmission paths 1005-1, . . . , 1005-N. The extraction step S5 is implemented by the coupler 70-1, . . . , 70-N.

A switching step S6 comprises switching the selected one of the feedback signal 2100-1, 2100-2, . . . , 2100-N into the common feedback path 1050. The switching step S6 may be carried out using the switch 100.

In an attenuation step S7 an attenuation of the selected one of the feedback signals 2100-1, 2100-2, . . . , 2100-N may be achieved. The attenuation step S7 may be of interest in order to adapt a power level of the selected one of the feedback signal 2100-1, 2100-2, . . . , 2100-N to a power level accepted by the down-conversion and filtering unit 120.

The selected one of the feedback signals 2100-1, 2100-2, . . . , 2100-N is down converted to an IF frequency and filtered by the down-converting and filtering unit 120 at step S8, as is known in the art, following the attenuation step S7.

The down conversion step S8 is followed by an analogue-to-digital conversion step S9. The analogue-to-digital conversion is carried out by the analogue-to-digital converter 140. The analogue-to-digital conversion could be carried out by a delta-sigma analogue-to-digital converter, as is known from the aspect shown in FIG. 5.

It should be noted that the method is described with the analogue-to-digital conversion step S9 carried out after the down conversion step S8. It will be appreciated that this is not limiting and that the analogue-to-digital conversion step S9 could be performed before the down conversion step S8.

The digitised down-converted feedback signal 2100-1, 2100-2, . . . , 2100-N is passed to the correction signal calculation unit 160, where the correction signal calculation unit 160 may extract the differences between the selected one of the feedback signals 2100-1, 2100-2, . . . , 2100-N and the payload signal 2000. The extraction step S10 yields the differences mainly introduced due to the nonlinearities of the second amplifier 60-1, . . . , 60-N. The differences may comprise a difference in amplitude and/or phase between the payload signal and the selected one of the feedback signals 2100-1, 2100-2, . . . , 2100-N. Methods and devices for extracting the differences between two signals are known in the art and will not be further explained here (step S10).

A single correction signal 2010 is derived from the new updated predistortion coefficients and generated by the correction signal generation unit 162. The single correction signal 2010 is passed onto the single correction signal path 1010 (step S11).

The single correction signal 2010 is split by the splitter 188 into three identical correction signals 2010-1, 2010,-2, . . . , 2010-N, which are fed on the three paths 1010-1, 1010-2, . . . , 1010-N, leading to the selected one of the correction signal combiners 50-1, 50-2, . . . , 50-N. The phase and amplitude of the correction signals 2010-1, 2010,-2, . . . , 2010-N may be modified by the phase controller 507-1, 507-2, . . . , 507-N and the amplitude controller 506-1, 506-2, . . . , 506-N, respectively, before reaching the combiner 50-1, 50-2, . . . , 50-N (step S12).

FIG. 9 shows an overview of the method according to another aspect of this disclosure. In this aspect the method for linearising is used in conjunction with the active antenna array of FIGS. 2 to 5.

In step S21, a payload signal 2000 is converted to the analogue payload signal 2000-1, 2000-2, . . . , 2000-N. The analogue payload signal 2000-1, 2000-2, . . . , 2000-N is forwarded along the transmission path 1005-1, 1005-2, . . . , 1005-N. The analogue payload signal 2000-1, 2000-2, . . . , 2000-N is upconverted into intermediate frequencies and amplified by IF amplifier 37-1, 37-2, . . . , 37-N (step S22).

In step S23, the analogue payload signal 2000-1, 2000-2, . . . , 2000-N is passed to the analogue IF correction signal combiner 50-1, 50-2, . . . , 50-N, wherein a correction signal 2010-1, 2010-2, . . . , 2010-N is combined with the analogue payload signal 2000-1, 2000-2, . . . , 2000-N thereby forming the corrected payload signal 2050-1, . . . , 2050-N. The analogue payload signal 2000-1, 2000-2, . . . , 2000-N is the intended signal to be relayed along the transmission paths 1005-1, 1005-2, . . . , 1005-N. The corrected payload signal 2050-1, . . . , 2050-N is forwarded along the transmission paths 1005-1, 1005-2, . . . , 1005-N. The combining of the correction signal 2010-1, 2010-2, . . . , 2010-N with the analogue payload signal 2000-1, 2000-2, . . . , 2000-N comprises adding and/or multiplying correction signal 2010-1, 2010-2, . . . , 2010-N to the analogue payload signal 2000-1, 2000-2, . . . , 2000-N.

An up-conversion and filtering of the corrected payload signal 2050-1, . . . , 2050-N (step S24) follows the step S23 of correcting the selected payload signal 2000-1, 200-2, . . . , 2000-N. The step S24 of up-conversion and filtering comprises the use of the amplifiers 60-1, 60-2, . . . , 60-N and of the band pass filters 65-1, 65-2, . . . , 65N. The band pass filter 65-1, 65-2, . . . , 65N may comprise a filtering characteristic as defined by the communication protocol.

An extraction step S25 of extracting comprises the extraction of a feedback signal 2100-1, 2100-2, . . . , 2100-N out of the transmission paths 1005-1, . . . , 1005-N. The extraction is implemented by the coupler 70-1, . . . , 70-N.

A summing step S26 comprises summing, by the adder 200, the feedback signals 2100-1, 2100-2, . . . , 2100-N. The output 205 of the adder 200 is a single composite feedback signal 2150. The output of the adder 205 is passed on the feedback path 1500.

In an attenuation step S27 an attenuating of the composite feedback signal 2150 may be achieved. The attenuation step S27 may be of interest in order to adapt a power level of the composite feedback signal 2150 to a power level accepted by the downconversion and filtering unit 120.

The composite feedback signal 2150 is down converted to IF frequencies and filtered by the down-converting and filtering unit 120 at step S28, as is known in the art, following the optional attenuation step S27. The down conversion step S28 is followed by an analogue-to-digital conversion step S29. The analogue-to-digital conversion is carried out by the analogue-to-digital converter 140.

It should be noted that the method is described with the analogue-to-digital conversion step S29 carried out after the down conversion step S28. It will be appreciated that this is not limiting and that the analogue-to-digital conversion step S29 could be performed before the down conversion step S28.

The digitised down-converted composite feedback signal 2150 is passed to the correction signal calculation unit 160, where the correction signal combiner coefficient calculation unit 160 may extract the differences between the composite feedback signal 2150 and the payload signal 2000-1, . . . , 2000-N and generate therefrom a single correction signal 2010 (step S30). Methods and devices for extracting the differences between two signals are known in the art and will not be further explained here.

A single correction signal 2010 is derived from the new updated predistortion coefficients and generated by the correction signal generation unit 162. The single correction signal 2010 is passed onto the single correction signal path 1010 (step S31).

The single correction signal 2010 is split by the splitter 188 into three identical correction signals 2010-1, 2010,-2, . . . , 2010-N, which are fed on the three paths 1010-1, 1010-2, . . . , 1010-N, leading to the selected one of the correction signal combiners 50-1, 50-2, . . . , 50-N. The phase and amplitude of the correction signals 2010-1, 2010,-2, . . . , 2010-N may be modified by the phase controller 507-1, 507-2, . . . , 507-N and the amplitude controller 506-1, 506-2, . . . , 506-N, respectively, before reaching the combiner 50-1, 50-2, . . . , 50-N (step S32).

The disclosure further relates to a computer program product embedded on a non-transitory computer readable medium. The computer program product comprises executable instructions for the manufacture of the active antenna array 1 according to the present invention.

The disclosure relates to yet another computer program product. The yet another computer program product comprises instructions to enable a processor to carry out the method for digitally predistorting a payload signal 2000 according to the invention.

While various embodiments of the present invention have been described above, it should be understood that they have been presented by way of example, and not limitation. It will be apparent to persons skilled in the relevant arts that various changes in form and detail can be made therein without departing from the scope of the invention. In addition to using hardware (e.g., within or coupled to a central processing unit (“CPU”), micro processor, micro controller, digital signal processor, processor core, system on chip (“SOC”) or any other device), implementations may also be embodied in software (e.g. computer readable code, program code, and/or instructions disposed in any form, such as source, object or machine language) disposed for example in a non-transitory computer useable (e.g. readable) medium configured to store the software. Such software can enable, for example, the function, fabrication, modelling, simulation, description and/or testing of the apparatus and methods describe herein. For example, this can be accomplished through the use of general program languages (e.g., C, C++), hardware description languages (HDL) including Verilog HDL, VHDL, and so on, or other available programs. Such software can be disposed in any known computer useable medium such as semiconductor, magnetic disc, or optical disc (e.g., CD-ROM, DVD-ROM, etc.). The software can also be disposed as a non-transitory computer data signal embodied in a computer useable (e.g. readable) transmission medium (e.g., carrier wave or any other medium including digital, optical, analogue-based medium). Embodiments of the present invention may include methods of providing the apparatus described herein by providing software describing the apparatus and subsequently transmitting the software as a computer data signal over a communication network including the internet and intranets.

It is understood that the apparatus and method describe herein may be included in a semiconductor intellectual property core, such as a micro processor core (e.g., embodied in HDL) and transformed to hardware in the production of integrated circuits. Additionally, the apparatus and methods described herein may be embodied as a combination of hardware and software. Thus, the present invention should not be limited by any of the above-described exemplary embodiments, but should be defined only in accordance with the following claims and their equivalents.

### LIST OF REFERENCE NUMERALS

15 digital signal processor (DSP)
20-1, 20-2, . . . , 20-N first digital-to-analogue conversion block
28-1, 28-2, . . . , 28-N. first filter
30-1, 30-2, . . . , 30-N first up-conversion block
35-1, 35-2, . . . , 35-N first up-mixer
36-1, 36-2, . . . , 36-N second filter
37-1, 37-2, . . . , 37-N. first amplifier
38 a local oscillator
50-1, 50-2, . . . , 50-N correction signal combiner
52-1, 52-2, . . . , 52-N second up-conversion block
55-1, 55-2, . . . , 55-N second up-mixer
56-1, 56-2, . . . , 56-N third filter
60-1, 60-2, . . . , 60-N second amplifier
65-1, 65-2 . . . , 65-N fourth filter
70-1, . . . , 70-N. coupler
95-1, . . . , 95-N antenna elements
100 switch
102-1, 102-2, . . . , 102-N switch inputs
105 switch output
110 attenuator
140 A/D converter
160 correction signal calculation unit
161 predistortion calculation unit
162 correction signal generation unit
180 second digital-to-analogue conversion block
181 fifth filter
182 third up-conversion block
185 third up-mixer
186 sixth filter
187 third amplifier
188 splitter
506-1, 506-2, . . . , 506-N amplitude controller
507-1, 507-2, . . . , 507-N phase controller
200 adder
202-1, 202-2, . . . , 202-N adder inputs
205 adder output
320-1, 320-2, . . . , 320-N digital-to-analogue conversion block
328-1, 328-2, . . . , 328-N. first filter
330-1, 330-2, . . . , 330-N first up-conversion block
335-1, 335-2, . . . , 335-N up-mixer
336-1, 336-2, . . . , 336-N filter
337-1, 337-2, . . . , 337-N. amplifier
338 a local oscillator
350-1, 350-2, . . . , 350-N correction signal combiner
429-1, 429-2, . . . , 429-N digital to analogue converter
430-1, 430-2, . . . , 430-N quadrature up-converter
431-1, 431-2, . . . , 431-N quadrature splitter
438 second local oscillator
530-1, . . . , 530-N Delta-sigma digital-to-analogue converters
506-1, 506-2, 506-3 amplitude controller
507-1, 507-2, 507-3 phase controller

### Paths

1000-1, 1000-2, . . . , 1000-N antenna path
1005-1, 1005-2, . . . , 1005-N transmission path
1010-1, 1010-2, 1010-N calibration signal path
1050 feedback path

### Signals

2000 Payload signal
2000-1, . . . , 2000-N, analogue payload signal
2050-1, 2050-2, . . . , 2050-N corrected payload signal
2100-1, 2100-2, . . . , 2100-N Feedback signal
2150 single composite feedback signal

1. An active antenna array comprising:
a digital signal processor connected to a plurality of digital-to-analogue conversion blocks;
a plurality of antenna elements;
a plurality of transmission paths, whereby an individual one of the plurality of transmission paths is connected between an individual one of the digital-to-analogue conversion blocks and an individual one of the plurality of antenna elements, whereby an individual one of the plurality of transmission paths comprises a correction signal combiner and a feedback coupler;
a plurality of paths connected between individual ones of the feedback couplers and a single feedback combiner
a single feedback path connected between the single feedback combiner and a correction signal calculation unit; and
a single correction signal path connected between the correction signal calculation unit and at least two of the correction signal combiners.

2. The active antenna array of claim 1, wherein the single feedback combiner is one of a multi-way switch or an adder.

3. The active antenna array of claim 1, wherein the digital to analogue conversion block is one of a digital-to-analogue converter, a delta-sigma digital-to-analogue converter or a pair of digital-to-analogue converters supplying I & Q signals.

4. The active antenna array of claim 1, further comprising a correction signal upconverter for upconverting the correction signal from a first frequency to a second frequency, thus generating an upconverted correction signal, and wherein the correction signal combiner is a correction signal summer adapted to operate at the second frequency and add the upconverted correction signal to a transmission signal.

5. The active antenna array of claim 1, wherein the correction signal combiner is adapted to multiply the single correction signal with a transmission signal.

6. The active antenna array of claim 1, wherein correction signal calculation unit comprises a predistorsion calculation unit and a correction signal generation unit.

7. The active antenna array of claim 1, wherein the single correction signal path comprises at least one of an amplitude controller and a phase controller.

8. A method for predistortion of radio signals comprising:
correcting two or more of a plurality of analogue payload signals, thereby
obtaining at least two corrected payload signals,
amplifying the at least two corrected payload signals,
extracting a portion of one or more of the at least two corrected payload signals as a single feedback signal, and
adapting the correcting of the two or more of a plurality of analogue payload signals by combining the two or more of the more of the plurality of analogue payload signals with a correction signal generated by comparing the single feedback signal with at least one of the two or more of the plurality of analogue payload signals.

9. The method according to claim 8, further comprising switching between individual ones of the feedback signals; and using the switched one of the individual ones of the feedback signals for the generation of the correction signal of a corresponding one of the plurality of analogue payload signals.

10. The method according to claim 8, further comprising forming a composite feedback signal from a plurality of the at least one feedback signals; and using the composite feedback signal for the generation of the correction signal of a plurality of the analogue payload signals.

11. A computer program product comprising a non-transitory computer-usable medium having control logic stored therein for causing a computer to manufacture an active antenna array for a mobile communications network, the active antenna array comprising:
a digital signal processor connected to a plurality of digital-to-analogue conversion blocks;
a plurality of antenna elements;
a plurality of transmission paths, whereby an individual one of the plurality of transmission paths is connected between an individual one of the digital-to-analogue conversion blocks and an individual one of the plurality of antenna elements, whereby an individual one of the plurality of transmission paths comprises a correction signal combiner and a feedback coupler;
a plurality of paths connected between individual ones of the feedback couplers and a single feedback combiner
a single feedback path connected between the single feedback combiner and a correction signal calculation unit; and
a single correction signal path connected between the correction signal calculation unit and at least two of the correction signal combiners

12. A computer program product comprising a non-transitory computer-usable medium having control logic stored therein for causing an active antenna to execute a method for transmitting a plurality of individual radio signals comprising:
a. first computer readable code means for correcting two or more of a plurality of analogue payload signals, thereby obtaining at least two corrected payload signals;
b. second computer readable code means for amplifying the at least one corrected payload signal
c. third computer readable code means for extracting a portion of one or more of the at least one corrected payload signal as a single feedback signal
d. fourth computer readable control means for adapting the correcting of the two or more of a plurality of analogue payload signals by combining the two or more of the more of the plurality of analogue payload signals with a correction signal generated by comparing the single feedback signal with at least one of the two or more of the plurality of analogue payload signals.
